(19) United States
(12) Patent Application Publication
(10) Pub. No.: US 2025/0342044 A1
(43) Pub. Date: Nov. 6, 2025

(54) SYSTEMS AND METHODS FOR PROVIDING GOVERNANCE AS FINITE STATE MACHINES

(71) Applicant: JPMORGAN CHASE BANK, N.A., New York, NY (US)

(72) Inventors: Michael George NORMAN, Edinburgh (GB); Harshini NAKERIKANTI, Hyderabad (IN); Lenny Leonardo BLUM, Armonk, NY (US); David LAURANCE, Ann Arbor, MI (US); Dominique TRAN, Frisco, TX (US)

(21) Appl. No.: 18/750,748

(22) Filed: Jun. 21, 2024

(30) Foreign Application Priority Data
May 6, 2024 (IN) 202411035656

(51) Int. Cl. G06F 9/448

(52) U.S. Cl. CPC G06F 9/4498

(57) ABSTRACT

Systems and methods for providing governance as finite state machines are disclosed. A method may include: a computer program in a compute environment: (1) receiving state machine definitions for a plurality of state machines; (2) saving the state machine definitions in a graph database; (3) receiving an event from one of a plurality of governed systems or a peer computer program in a peer compute environment, an event; (4) querying the graph database for one of the state machine definitions for the event; (5) instantiating a state machine instance using the state machine definitions; (6) executing a transition based on a current state; (7) receiving an instruction from the state machine; and (8) sending the instruction to one or more of the governed systems; wherein the one or more governed systems implement the instruction.

### RELATED APPLICATIONS

This application claims priority to, and the benefit of, Indian patent application Ser. No. 202411035656, filed May 6, 2024, the disclosure of which is hereby incorporated, by reference, in its entirety.

### BACKGROUND OF THE INVENTION

### 1. Field of the Invention

Embodiments are generally directed to systems and methods for providing governance as finite state machines.

### 2. Description of the Related Art

Within the context of Governance (for example, Access Governance or Artificial Intelligence (AI) Governance), there are three general sets of concepts. The first set is based on what can happen. This set includes definitions of processes that we wish to observe, perform or control, such as access to systems, approval workflows for creation of AI models, fulfillment/reconciliation of data into identity stores, validation of AI models for bias and drift, etc. The second is based on what should happen. This set includes conditions that can be used to determine certain processes that can be performed, given a model of an organization, its systems, people, data, etc. The third is what has happened. This set includes records of processes that have been applied and their outcomes; issues of provenance and trust of data being fed into the conditions; the system of origination, the transformations that have happened to it, etc.

All three elements are required to be combined to ensure correct governance of an enterprise.

### SUMMARY OF THE INVENTION

Systems and methods for providing governance as finite state machines are disclosed. According to an embodiment, a method may include: (1) receiving, by a computer program in a compute environment, state machine definitions for a plurality of state machines; (2) saving, by the computer program, the state machine definitions in a graph database; (3) receiving, by the computer program, an event from one of a plurality of governed systems or a peer computer program in a peer compute environment, an event; (4) querying, by the computer program, the graph database for one of the state machine definitions for the event; (5) instantiating, by the computer program, a state machine instance using the state machine definitions; (6) executing, by the state machine instance, a transition based on a current state; (7) receiving, by the computer program, an instruction from the state machine; and (8) sending, by the computer program, the instruction to one or more of the governed systems; wherein the one or more governed systems implement the instruction.

In one embodiment, the state machine definitions comprise states, transitions, events, triggers, and actions.

In one embodiment, the state machine definitions are based on a governance model.

In one embodiment, the state machine definitions are written in resource description framework.

In one embodiment, the event comprises a source and a definition.

In one embodiment, the method may also include: retrieving, by the computer program, rules for the event from the graph database, wherein the rules comprise pre-condition, post-conditions, and runtime conditions; and applying, by the computer program, the rules to the event.

In one embodiment, the compute environment comprises a sandbox within a web browser, a cloud environment, etc.

In one embodiment, the method may also include ignoring, by the computer program, the event that does not have a material impact on any of the governed systems.

In one embodiment, at least one of the governed systems comprises a software system.

In one embodiment, at least one of the governed systems comprises a physical device that supports a software interface for control purposes.

In one embodiment, each of the governed systems comprises a control point that listens for events on the governed systems and forwards the events to the computer program.

In one embodiment, a plurality of the state machine instances send events to each other.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for providing governance as finite state machines according to an embodiment;

FIGS. 2A and 2B depict a method for providing governance as finite state machines according to an embodiment;

FIG. 3 depicts an exemplary computing system for implementing aspects of the present disclosure.

### DETAILED DESCRIPTION OF PREFERRED EMBODIMENTS

Systems and methods for providing governance as finite state machines are disclosed.

A “state machine” is a definition of a directed graph, where the nodes in the directed graph are “states,” and the edges are “transitions.” Each transition has one or more events that act as “triggers,” as well as a set of actions that can happen before, during, or after the transition.

A software system that executes state machines (a State machine Executor, or SME) typically has many such definitions. Each definition has a different set of states, transitions, triggering events, and actions.

The Events and Transitions defined in each State Machine are definitions of things that “can happen.” The Actions can express things that “can happen,” or things that “should happen.”

The events, transitions, and actions that are defined in a state machine comprise a consistent set of behaviors that respond to or initiate external events. In order to utilize this state machine definition, the state machine executor must create a state machine instance, that is, an in-memory representation of the state machine that is bound to a particular execution context, such that the state machine instance has the same states, transitions, events and actions that are defined in the state machine. Once instantiated, the state machine instance contains the directed graph in memory, along with an initial state based upon the execution context. The initial state is considered to be the “current state” in advance of any event arrivals.

On receipt of an event, a state machine executor will (depending on the destination of the Event) either construct a new representation of a state machine instance or process it in the context of an existing state machine instance. The state machine executor may use attributes of the received event to select a state machine and a transition within that instance that is bound to its current state. It then executes the transition and any associated actions. The state machine instance then waits for additional events to arrive.

For each subsequent event received by the state machine executor addressed to the state machine instance, it looks for a transition from the current state that is triggered by the event. If none is found, the state machine instance may ignore the event. If a suitable transition is found, the state machine instance executes (or “fires”) that transition, performs all defined actions (before, during, after), and changes the current state by navigating the graph along the transition edge to a new state node.

Whenever the state machine instance takes a transition, that represents something that “did happen,” and the event, transition, and actions taken may be logged in a graph database by the State Machine Executor.

The execution of the state machine may be linked to a model of the sequence of states through which it has moved. By persisting this sequence of states along with a history of events, the State Machine Executor is capable of supporting auditability.

The use of state machines to control governed systems is significantly advanced over a traditional rule-based approach to control systems in its ability to coordinate rule-based decisions in two dimensions. First, coordination can be done “across time”—considering how the software is built, how access is provisioned, how the software is deployed, and what happens dynamically while the software is executing. Second, coordination between rulesets can be achieved “across place”—with rules executing in parallel in multiple execution contexts.

In embodiments, rules may be distributed but coordinated. A decision may combine considerations from multiple contexts, for example, considering software construction, agent permissions and run-time considerations, to make a single access decision. This is a foundational capability that is not present in other rule-based control systems.

Embodiments may incorporate dynamic events and may respond as events occur. Each event may be considered against external conditions to determine what rules are applicable; then the applicable rules may be retrieved and applied in the context of the current deployed context. The control consequences of an event may not be fully evident at the time and place that the event occurs; in this situation, the local instance of the computer program responds by forwarding the event to other instances separated in time and place.

Decisions made in the context of one system-under-governance may take conditions into consideration that are determined in the context of another system-under-governance, and because of the way that rule execution is coordinated, the decisions are subject to formal proof of correctness.

A single set of logical rules may be evaluated in multiple execution contexts with different metamodels (e.g., different cloud services) by specifying a set of inference rules to translate from platform-specific constructs to a generic metamodel and using the generic metamodel as input to the common ruleset.

In embodiments, the state machines may be defined in Resource Description Framework (RDF). A benefit of using RDF is that new state machines may be implemented as a part of configuring a computer program, so different instances of the computer program in a distributed deployment can contain distinct state machines.

In one embodiment, while state machine instances in different processors may operate independently of one another, embodiments may provide the ability for state machine instances to communicate with one another by sending events through a suitable network connection or interface.

Embodiments may adapt to changes in the systems under governance by modifying state machine definitions or by introducing new state machine definitions.

Embodiments may implement detective, preventive, or corrective control decisions, and can communicate those control decisions either to the systems under governance or to separate computer systems for enforcement.

Embodiments may coordinate a set of controls across a set of multiple systems under governance, so that detective, preventive or corrective control decisions can be distributed to different individual systems, such that the intended effect of the control decisions is achieved cooperatively across the set of systems under governance.

Embodiments may coordinate a set of related controls over time, so that different control decisions can be taken when a system under governance is built, deployed, and operated, and the decisions over time aggregate to achieve the intended control effect.

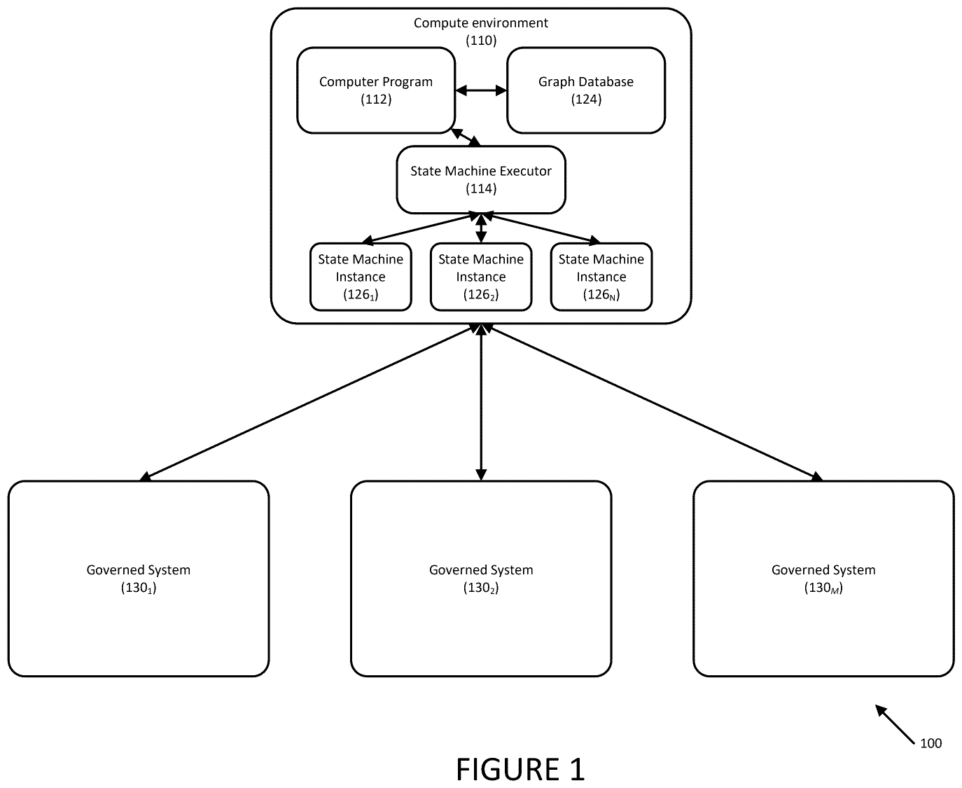

Referring to FIG. 1, a system for providing governance as finite state machines is disclosed according to an embodiment. System 100 may include compute environment 110, which may include one or more computer program 112 that may interface with graph database 124. A plurality of state machine instances 126 (e.g., state machine instance 1261, state machine instance 1262, . . . state machine instance 126N) may be provided. The number of state machine instances 126 may vary as is necessary and/or desired and may be dynamic.

State machine executor 114 may interface with computer program 112 and state machine instances 126. State machine executor 114 may instantiate one or more state machine instances 126, or may use an existing state machine instance 126 to process an event.

In one embodiment, computer program 112 may include state machine executor 114 and state machine instances 126.

Graph database 124 may include definitions for state machines. The definitions may include the states, transitions, events, triggers, and actions for each state machine.

In one embodiment, graph database may be provided in compute environment 110. In another embodiment, graph database 124 may be provided externally to compute environment 110.

Communication between the computer program 112 and graph database 124 may be via application programming instances (APIs) and may cross over a bus or network that interconnects the two.

Compute environment 110 may interface with a plurality of governed systems 130 (e.g., governed system 1301, governed system 1302, governed system 130M). Computer program 112 may use state machines 126 to make control decisions for the governed systems 130. The number of governed systems 130 may vary as is necessary and/or desired.

Governed systems 130 may be software systems, but may also be separate physical devices that support software interfaces for control purposes. Examples of such devices may include sensors (e.g., thermostats), actuators (e.g., HVAC systems), etc.

Computer program 112 and one or more governed systems 130 may share a computing device, or one or more governed systems 130 may be deployed separately from computer program 112. Communications between computer program 112 and governed systems 130 may be implemented based on available connectivity. Examples of connectivity mechanisms include TCP/IP networks (internet), direct point-to-point connections, interprocess communication protocols supported by compute environment 110, etc.

Computer program 112 may receive events from governed systems 130 and may issue instructions to governed systems 130. Governed systems 130 may implement the issued events.

In some embodiments, a number of peer compute environments (not shown) may be provided for compute environment 110, and each peer compute environment may have its own peer computer program (not shown). The peer computer programs may share some or all data in graph database 124, or each peer computer program may have a separate graph database (not shown). The peer computer programs (including computer program 112) may communicate with one another, passing events from one to another as needed to reflect decisions being made. Each computer program may inspect an event as it arrives and route it to the correct state machine 126.

Alternatively, in another embodiment, compute environment 110 may be provided on a single computer processor.

In one embodiment, compute environment 110 may be a web browser with a sandbox or other sandboxed environment, and the functionality of computer program 112, state machine executor 114, and state machine instances 126 may be provided within the sandbox. This provides portability between browsers and hardware.

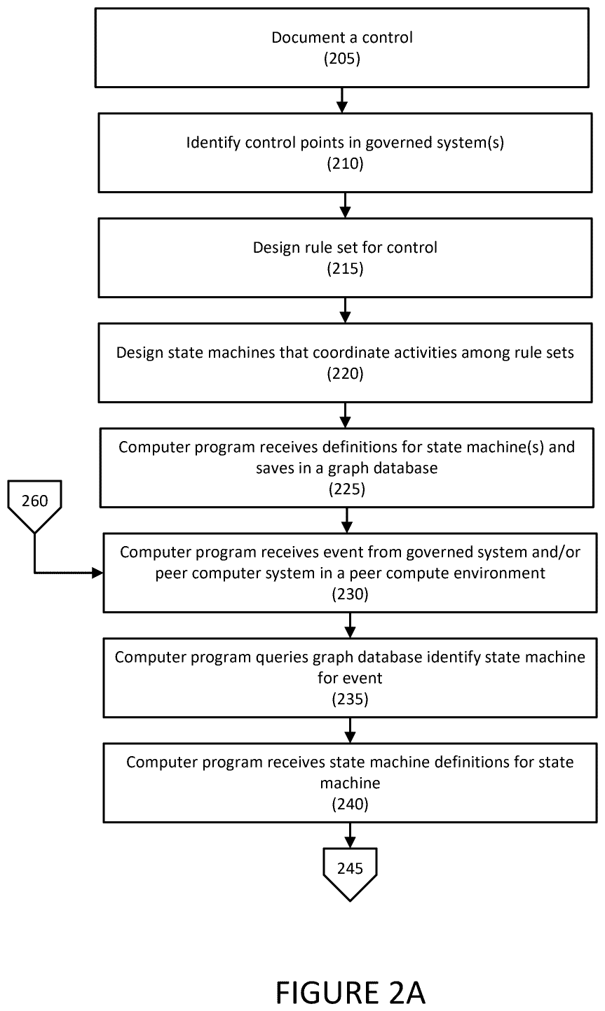

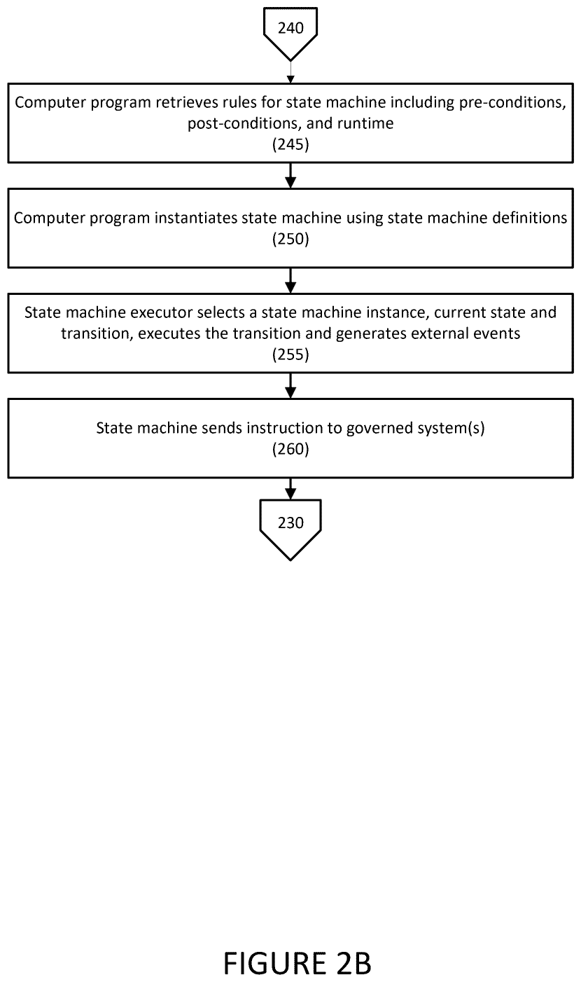

Referring to FIGS. 2A and 2B, a method for providing governance as finite state machines is disclosed according to an embodiment.

In step 205, a user may document a control. For example, the control may constrain the operation of one or more governed systems.

In one embodiment, a control may be considered to be a set of rules that operates on the governed system(s), either before or while that governed system is operating, with the intended effect of ensuring that the governed system achieves or remains in a desirable state. For example, a security control has the intended effect that the system remains secure in the face of intended or accidental compromise, and a resilience control has the intended effect that the system remains operationally stable and available in the face of faults.

“Intended effects” may be formulated at different levels. The way that the intended effect is articulated reflects some assumptions about how the control should function.

In step 210, the user may identify control points in the governed systems. A control point is a point in the governed system where a control can be inserted. Since controls are formulated as rules, a control point is a point in the system where it is possible to listen for events and respond by evaluating rules.

Control points may be separated “across space and time.” That is, a rule may be executed in response to events while user roles and permissions are provisioned (“request that we grant David the role of Trader”), events that occur during system operations (“David initiates a Trade request”), or events that occur during program design and build (“recompile and rebuild this source code library”).

In step 215, the user may design a rule set for the control. Each rule set may be logically associated with a control point, and with events that may occur at that control point. Control points and rule sets may be separated across space and time.

In step 220, the user may design a state machine that coordinates activities by organizing states and transitions. The state machine may establish the order in which events are expected to occur, and may keep track of execution context in between rule sets so that the context from one rule set is available to subsequent rule sets.

A state machine can be understood as a collection of discrete states in which an entity may be, a set of directed transitions between states, a set of events that trigger those transitions, and a set of actions that the program will take before, during or after a transition is processed.

Separation in time and space may be achieved by defining multiple state machines that coordinate with one another. State machines may coordinate by sending and receiving events, such that the events share execution context between state machines.

In step 225, a computer program executed in a compute environment in the cloud may receive the definitions for one or more state machines, including states, transitions, events, triggers, and actions, and may save the definitions in a graph database. The definitions may be based on a governance model for an enterprise.

In one embodiment, the state machine definitions may be written in the resource description framework, or RDF.

In step 230, the computer program may receive an event from one of a plurality of governed systems within the enterprise, and/or from a peer computer program in a peer compute environment. If multiple events are received the computer program may process the event in the order in which they are received.

In one embodiment, the event may be from a governed system, another computer program in another compute environment, or from an external system.

Each event may be associated with a source and a destination, which may be modeled as instances of state machines.

In one embodiment, if the event does not have a material impact on any of the governed systems, the event may be ignored.

In step 235, the computer program may query the graph database with the event and rules to apply to the event, and the graph database may return the rules.

In step 240, the computer program may apply rules (e.g., pre-conditions, post-conditions, and transition code) to the event. The preconditions and postconditions may remain stable over time, but the effect of these conditions changes if a rule refers to things that have happened or makes use of an attribute that was changed as a result of a previous event. In other words, the current context is affected by past events. For example, the result of applying the rules is to select a transition, execute any associated instructions, and use the transition to change the current state of the state machine instance. The associated instructions (pre, transition, and post) may modify attributes in the state machine instance and/or send events to systems under governance or SMEs. Modifying Attributes within the state machine instance keeps track of the execution context. Sending events is how different state machine instances communicate with one another, and this implements the complex behavior across space and time.

In step 245, the computer program may retrieve state machine definitions for a state machine from the graph database.

In step 250, the computer program may instantiate the state machine, or may use an existing state machine, to process the event. The choice as to whether to instantiate a new state machine, or to use an existing state machine may be based on the destination address of the event. In the case where the destination is an existing state machine instance, the existing state machine instance may be used. In the case where it is a state machine “class,” the state machined may be instantiated (subject to the condition associated with its initial transition)

In step 255, the state machine executor selects a state machine instance, current state and transition, and executes that transition with any actions pre-conditions, post-conditions, and runtime conditions received from the graph database and may generate an instruction in response to the event.

Before execution, a new state machine may be configured, or an existing state machine may be updated (e.g., by modifying the behavior during a specific transition to add functionality or correct an error).

In step 260, the state machine may send the instruction to one or more governed system(s). The governed systems may implement the instruction. For example, a state machine intended to manage authentication could alert an external system if the number or frequency of failed authentications hits a specific threshold.

In one embodiment, the graph database may be updated with the instruction.

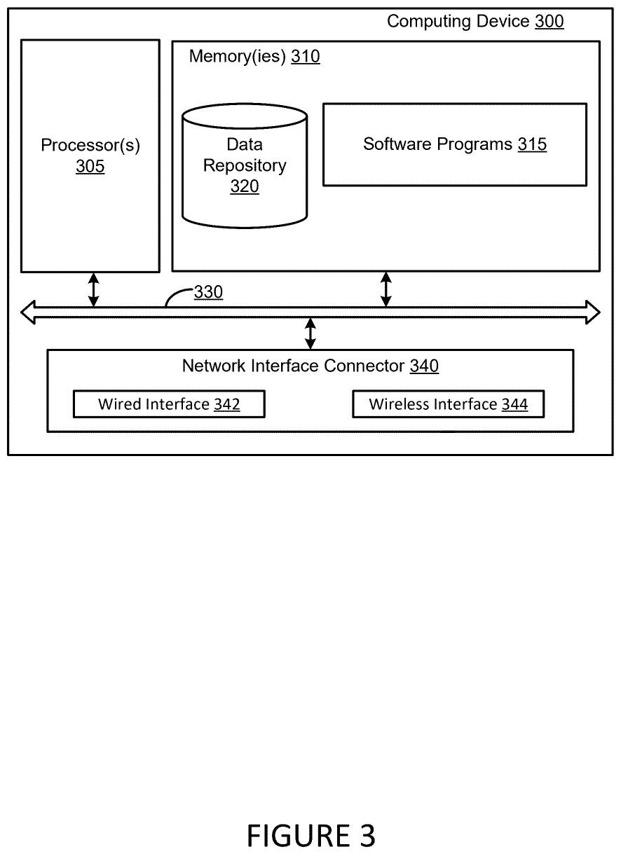

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a computer program in a compute environment, state machine definitions for a plurality of state machines;
saving, by the computer program, the state machine definitions in a graph database;
receiving, by the computer program, an event from one of a plurality of governed systems or a peer computer program in a peer compute environment, an event;
querying, by the computer program, the graph database for one of the state machine definitions for the event;
instantiating, by the computer program, a state machine instance using the state machine definitions;
executing, by the state machine instance, a transition based on a current state;
receiving, by the computer program, an instruction from the state machine; and
sending, by the computer program, the instruction to one or more of the governed systems;
wherein the one or more governed systems implement the instruction.

2. The method of claim 1, wherein the state machine definitions comprise states, transitions, events, triggers, and actions.

3. The method of claim 1, wherein the state machine definitions are based on a governance model.

4. The method of claim 1, wherein the state machine definitions are written in resource description framework.

5. The method of claim 1, wherein the event comprises a source and a definition.

6. The method of claim 1, further comprising:
retrieving, by the computer program, rules for the event from the graph database, wherein the rules comprise pre-condition, post-conditions, and runtime conditions; and
applying, by the computer program, the rules to the event.

7. The method of claim 1, wherein the compute environment comprises a sandbox within a web browser.

8. The method of claim 1, wherein the compute environment comprises a cloud environment.

9. The method of claim 1, further comprising:
ignoring, by the computer program, the event that does not have a material impact on any of the governed systems.

10. The method of claim 1, wherein at least one of the governed systems comprises a software system.

11. The method of claim 1, wherein at least one of the governed systems comprises a physical device that supports a software interface for control purposes.

12. The method of claim 1, wherein each of the governed systems comprises a control point that listens for events on the governed systems and forwards the events to the computer program.

13. The method of claim 1, wherein a plurality of the state machine instances send events to each other.
